(19) United States
(12) Patent Application Publication
(10) Pub. No.: US 2026/0179482 A1
(43) Pub. Date: Jun. 25, 2026

(54) APPARATUS AND METHOD FOR PROVIDING TRAFFIC INFORMATION

(71) Applicants: HYUNDAI MOTOR COMPANY, Seoul (KR); KIA CORPORATION, Seoul (KR)

(72) Inventor: Nam Hyuk Kim, Hwaseong-si (KR)

(73) Assignees: HYUNDAI MOTOR COMPANY, Seoul (KR); KIA CORPORATION, Seoul (KR)

(21) Appl. No.: 19/230,295

(22) Filed: Jun. 6, 2025

(30) Foreign Application Priority Data
Dec. 23, 2024 (KR) 10-2024-0194703

(51) Int. Cl. G08G 1/01; B60W 30/18; G08G 1/052

(52) U.S. Cl. CPC G08G 1/0133; B60W 30/18159; G08G 1/052

(57) ABSTRACT

An apparatus for providing traffic information includes a memory that stores a program instruction; and a processor that executes the program instruction. The processor may identify a driving road before a host vehicle among a plurality of vehicles enters an intersection based on a driving direction of the host vehicle; dynamically identify a non-host vehicle among the plurality of vehicles while the host vehicle is driving on the driving road, the non-host vehicle located in a first section within a preset distance from a starting point of the intersection on the driving road; identify the non-host vehicle as an intersection-blocking predicted vehicle based on the non-host vehicle being stopped; provide information related to the intersection to the host vehicle driving on the driving road based on the identified intersection-blocking predicted vehicle; and control the host vehicle to enter the intersection before the identified intersection-blocking predicted vehicle enters the intersection.

### CROSS-REFERENCE TO RELATED APPLICATION

This application claims the benefit of and priority to Korean Patent Application No. 10-2024-0194703, filed in the Korean Intellectual Property Office on Dec. 23, 2024, the entire contents of which are incorporated herein by reference.

### TECHNICAL FIELD

The present disclosure relates to an apparatus and a method for providing traffic information. More particularly, the present disclosure to a technology for providing traffic information related to an intersection.

### BACKGROUND

Traffic congestion at intersections is a major issue worldwide. In particular, a practice known as “tailgating” is one of the main causes of congestion at intersections and surrounding roads. Tailgating is the act of forcibly entering an intersection before the signal changes even though it is impossible to pass via the intersection and impeding the passage of other vehicles trying to enter the intersection normally. This phenomenon occurs due to the driver's poor judgment, lack of information on the remaining signal time, reckless entry without considering the traffic congestion on a front road, or the like. As a result, tailgating causes congestion at intersections, and the congestion then spreads to surrounding roads and negatively impacts the overall transport network.

Conventional technologies provide information by utilizing the remaining time of a traffic light signal, such as dilemma zone prevention technology, to alleviate traffic congestion but have the limitation of not sufficiently considering the congestion of front and rear roads. Due to such technical limitations, a conventional scheme of requiring drivers to determine whether it is possible to enter an intersection increases the ambiguity and risk of determination for drivers, and the conventional scheme is not guaranteed to be effective based on the driver's tendencies.

The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure has been made to solve the above-mentioned problems occurring in the prior art while advantages achieved by the prior art are maintained intact.

One aspect of the present disclosure provides an apparatus and a method for providing traffic information capable of effectively alleviating traffic congestion occurring at an intersection by identifying an intersection-blocking predicted vehicle and additionally preventing the occurrence of an intersection-blocking predicted vehicle.

Another aspect of the present disclosure provides an apparatus and a method for providing traffic information capable of comprehensively analyzing traffic conditions of a front road and a rear road to inform a driver of whether the driver may pass via an intersection.

Still another aspect of the present disclosure provides an apparatus and a method for providing traffic information capable of improving the quality of a route guided by a real-time route search system and preventing unnecessary detours by reducing traffic congestion at an intersection.

Still another aspect of the present disclosure provides an apparatus and a method for providing traffic information capable of increasing user convenience by providing useful traffic information, such as alternative routes and expected congestion, to a vehicle entering an intersection.

Still another aspect of the present disclosure provides an apparatus and a method for providing traffic information capable of automatically determining whether an intersection may be passed and providing the information to the user. Thus, the burden on drivers to make their own decisions is reduced, and risks that may arise if a vehicle enters an intersection are minimized.

Still another aspect of the present disclosure provides an apparatus and a method for providing traffic information capable of supporting a user to make faster and more efficient decisions by providing the user with the results of determining whether an intersection is passable and the congestion level of a driving road.

The technical problems to be solved by the present disclosure are not limited to the aforementioned problems, and any other technical problems not mentioned herein should be clearly understood from the following description by those having ordinary skill in the art to which the present disclosure pertains.

According to one aspect of the present disclosure, an apparatus for providing traffic information includes a memory that stores a program instruction, and a processor that executes the program instruction. The processor may identify a driving road before a host vehicle among a plurality of vehicles enters an intersection based on a driving direction of the host vehicle. The processor may further dynamically identify a non-host vehicle among the plurality of vehicles while the host vehicle is driving on the driving road. The non-host vehicle is located in a first section within a preset distance from a starting point of the intersection on the driving road. The processor may further identify the non-host vehicle as an intersection-blocking predicted vehicle based on the non-host vehicle being stopped. The processor may further provide information related to the intersection to the host vehicle driving on the driving road based on the identified intersection-blocking predicted vehicle. The processor may further control the host vehicle to enter the intersection before the identified intersection-blocking predicted vehicle enters the intersection or drive along an alternative route.

According to an embodiment, the processor may identify the non-host vehicle as the intersection-blocking predicted vehicle based on at least one of a distance between the non-host vehicle and the intersection, a distance traveled by the non-host vehicle in the first section, a time that the non-host vehicle stays in the first section, a time that the non-host vehicle stops in the first section, a number of times that the at least one other vehicle stops in the first section, an average speed of the non-host vehicle, or any combination thereof.

According to an embodiment, the processor may identify the non-host vehicle as the intersection-blocking predicted vehicle based on a rate of change in the distance traveled by the non-host vehicle in the first section relative to the time when the non-host vehicle stays in the first section.

According to an embodiment, the processor may identify a location of a traffic light that exists closest to the starting point of the intersection and a distance to the starting point of the intersection as a reference distance. The processor may further determine the first section based on a value of a preset ratio for the reference distance.

According to an embodiment, the processor may identify a signal state of a traffic light at the intersection. The processor may further identify a remaining time until a driving signal changes to a stop signal or a caution signal. The processor may further identify the non-host vehicle as the intersection-blocking predicted vehicle based on the remaining time being less than a preset time.

According to an embodiment, the processor may identify a front road on which the non-host vehicle is able to pass via the intersection via the driving road. The processor may further determine a congestion level of the front road based on first traffic volume data including at least one of a length of the front road, a number of vehicles on the front road, a density of vehicles on the front road, a speed of a vehicle on the front road, or any combination thereof.

According to an embodiment, the processor may compare second traffic volume data of the front road collected during a preset past time period with the first traffic volume data to determine the congestion level of the front road.

According to an embodiment, the processor may determine a congestion level of the driving road based on a number of the plurality of vehicles driving on the driving road.

According to an embodiment, the processor may determine the congestion level of the driving road based on at least one of a signal time period in which a same signal is repeated at a traffic light at the intersection, an average value of a number of vehicles passing the intersection during the signal time period, a maximum value of a waiting time of the non-host vehicle during the signal time period, an average value of the waiting time of the non-host vehicle during the signal time period, a length of the driving road, an average speed of the non-host vehicle driving on the driving road, or any combination thereof.

According to an embodiment, the information related to the intersection may include at least one of a predicted congestion level of the intersection, a speed of the intersection-blocking predicted vehicle, a predicted time required to reach the starting point of the intersection, a number of intersection-blocking predicted vehicles, a signal state of a traffic light at the intersection, information for guiding an alternative route, or any combination thereof.

According to another aspect of the present disclosure, a method of providing traffic information includes identifying, by a processor, a driving road before a host vehicle among a plurality of vehicles enters an intersection based on a driving direction of the host vehicle. The method further includes dynamically identifying, by the processor, a non-host vehicle among the plurality of vehicles while the host vehicle is driving on the driving road. The non-host vehicle is located in a first section within a preset distance from a starting point of the intersection on the driving road. The method further includes identifying, by the processor, the non-host vehicle as an intersection-blocking predicted vehicle based on the non-host vehicle being stopped. The method further includes providing, by the processor, information related to the intersection to the host vehicle driving on the driving road based on the identified intersection-blocking predicted vehicle. The method further includes controlling the host vehicle to enter the intersection before the identified intersection-blocking predicted vehicle enters the intersection or drive along an alternative route.

According to an embodiment, identifying the non-host vehicle as the intersection-blocking predicted vehicle may include identifying, by the processor, the non-host vehicle as the intersection-blocking predicted vehicle based on at least one of a distance between the at least one other vehicle and the intersection, a distance traveled by the non-host vehicle in the first section, a time that the non-host vehicle stays in the first section, a time that the non-host vehicle stops in the first section, a number of times that the at least one other vehicle stops in the first section, an average speed of the non-host vehicle, or any combination thereof.

According to an embodiment, identifying the non-host vehicle as the intersection-blocking predicted vehicle may include identifying, by the processor, the non-host vehicle as the intersection-blocking predicted vehicle based on a rate of change in the distance traveled by the non-host vehicle in the first section relative to the time when the non-host vehicle stays in the first section.

According to an embodiment, identifying the non-host vehicle may include identifying, by the processor, a location of a traffic light that exists closest to the starting point of the intersection and a distance to the starting point of the intersection as a reference distance; and determining, by the processor, the first section based on a value of a preset ratio for the reference distance.

According to an embodiment, identifying the non-host vehicle as the intersection-blocking predicted vehicle may include identifying, by the processor, a signal state of a traffic light at the intersection; identifying, by the processor, a remaining time until a driving signal changes to a stop signal or a caution signal; and identifying, by the processor, the non-host vehicle as the intersection-blocking predicted vehicle based on the remaining time being less than a preset time.

According to an embodiment, the method may include identifying, by the processor, a front road on which the non-host vehicle is able to pass via the intersection via the driving road; and determining, by the processor, a congestion level of the front road based on first traffic volume data including at least one of a length of the front road, a number of vehicles on the front road, a density of vehicles on the front road, a speed of a vehicle on the front road, or any combination thereof.

According to an embodiment, determining the congestion level of the front road may include comparing, by the processor, second traffic volume data of the front road collected during a preset past time period with the first traffic volume data to determine the congestion level of the front road.

According to an embodiment, the method may further include determining, by the processor, a congestion level of the driving road based on a number of the plurality of vehicles driving on the driving road.

According to an embodiment, determining the congestion level of the driving road may include determining, by the processor, the congestion level of the driving road based on at least one of a signal time period in which a same signal is repeated at a traffic light at the intersection, an average value of a number of vehicles passing the intersection during the signal time period, a maximum value of a waiting time of the non-host vehicle during the signal time period, an average value of the waiting time of the one other vehicle during the signal time period, a length of the driving road, an average speed of the one other vehicle driving on the driving road, or any combination thereof.

According to an embodiment, the information related to the intersection may include at least one of a predicted congestion level of the intersection, a speed of the intersection-blocking predicted vehicle, a predicted time required to reach the starting point of the intersection, a number of intersection-blocking predicted vehicles, a signal state of a traffic light at the intersection, information for guiding an alternative route, or any combination thereof.

According to another aspect of the present disclosure, an apparatus for controlling a vehicle at an intersection includes a memory configured to store instructions and a processor operatively coupled to the memory and communication interfaces. The processor is configured to execute the instructions to receive, via the communication interfaces, real-time data including location, speed, and stop status of a plurality of vehicles on a driving road approaching an intersection. The processor is further configured to identify a non-host vehicle located within a predefined distance from a starting point of the intersection. The processor is further configured to determine whether the non-host vehicle satisfies a predefined blocking condition based on at least a stop duration of the non-host vehicle within the predefined distance. The processor is further configured to, in response to determining that the blocking condition is satisfied, generate control information comprising at least one of a lane change recommendation or a command to alter a route of a host vehicle to avoid intersection congestion. The processor is further configured to provide the control information to a vehicle control module or a driver interface system of the host vehicle. The blocking condition is satisfied when the non-host vehicle remains stopped for a time exceeding a threshold duration while located within the predefined distance from the intersection.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating an apparatus for providing traffic information according to an embodiment of the present disclosure;

FIG. 2 is a diagram illustrating examples of a driving road, a front road, and an intersection identified by an apparatus for providing traffic information according to an embodiment of the present disclosure;

FIG. 3A is a diagram illustrating a first section within a preset distance from the starting point of an intersection on a driving road identified by an apparatus for providing traffic information according to an embodiment of the present disclosure;

FIG. 3B is a graph illustrating changes in moving distance according to driving times of a plurality of vehicles identified by an apparatus for providing traffic information according to an embodiment of the present disclosure;

FIG. 4 is a flowchart illustrating an apparatus for providing traffic information or a method of providing traffic information according to an embodiment of the present disclosure;

FIG. 5 is a flowchart illustrating an example of a process for providing information related to an intersection by an apparatus for providing traffic information or a method of providing traffic information according to an embodiment of the present disclosure; and

FIG. 6 is a block diagram illustrating a computing system related to an apparatus for providing traffic information or a method of providing traffic information according to an embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the drawings. When the reference numerals to the components of each drawing is added, it should be noted that the identical or equivalent components are specified by the identical numeral even if the components are displayed on other drawings. Further, a detailed description of the related known configuration or function has been omitted when it is determined that it interferes with the understanding of the embodiment of the present disclosure.

Terms, such as first, second, A, B, (a), (b) or the like, may be used herein when describing components of the present disclosure. The terms are provided only to distinguish the elements from other elements, and the essences, sequences, orders, and numbers of the elements are not limited by the terms. In addition, the expression, such as “at least one of A, B, C, or any combination thereof,” may include A or B or C or any combination thereof, such as AB, BC, AC or ABC.

In addition, unless defined otherwise, all terms used herein, including technical or scientific terms, have the same meanings as those generally understood by those having ordinary skill in the art to which the present disclosure pertains. The terms defined in the generally used dictionaries should be construed as having the meanings that coincide with the meanings of the contexts of the related technologies and should not be construed as ideal or excessively formal meanings unless clearly defined in the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

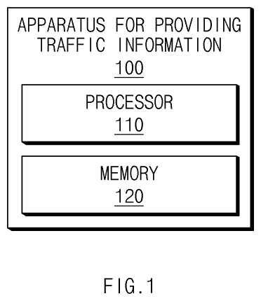

Hereinafter, embodiments of the present disclosure are described in detail with reference to FIGS. 1-6.

FIG. 1 is a block diagram illustrating an apparatus for providing traffic information according to an embodiment of the present disclosure.

Referring to FIG. 1, an apparatus 100 for providing traffic information according to an embodiment of the present disclosure may be implemented with a server and may provide traffic information by communicating with a plurality of vehicles or traffic control systems via a network.

According to an embodiment, the apparatus 100 for providing traffic information may include a processor 110 and a memory 120. The configuration of the apparatus 100 for providing traffic information shown in FIG. 1 is illustrative, and embodiments of the present disclosure are not limited thereto. For example, the apparatus 100 for providing traffic information may further include components not shown in FIG. 1.

According to an embodiment, the memory 120 may store commands or data. For example, the memory 120 may store one instruction or two or more instructions that, if executed by the processor 110, allow the apparatus 100 for providing traffic information to perform various operations.

According to an embodiment, the memory 120 may be implemented as a single chipset with the processor 110 and may store various information related to the apparatus 100 for providing traffic information. For example, the memory 120 may store information about the operation history of the processor 110.

According to an embodiment, the memory 120 may include a non-volatile memory (e.g., a read only memory, i.e., “ROM”) and a volatile memory (e.g., a random access memory, i.e. “RAM”). For example, information about a first section within a preset distance from the starting point of an intersection may be stored in the memory 120.

According to an embodiment, the processor 110 may identify a driving road before entering an intersection based on a driving direction of one of a plurality of vehicles.

According to an embodiment, one of the plurality of vehicles may include a host vehicle for which information related to an intersection is provided. Accordingly, among the plurality of vehicles, one vehicle may be determined that travels toward an intersection but has not yet entered the intersection.

According to an embodiment, an intersection may include a place where a plurality of roads intersects or merges. In detail, an intersection may mean a central area where a plurality of roads intersects or meets. The shape of an intersection may vary based on the intersection angle of the road, width, the number of lanes, and the direction of traffic flow. For example, if roads intersect perpendicularly, the intersection may have a geometric shape similar to a square or rectangle.

According to an embodiment, the processor 110 may identify one of a plurality of roads connected to an intersection. For example, the processor 110 may identify a plurality of vehicles driving on a plurality of roads connected to an intersection. In detail, the processor 110 may identify a plurality of vehicles driving on a road before the plurality of vehicles enters an intersection. In other words, the processor 110 may identify the plurality of vehicles driving toward the intersection.

According to an embodiment, the processor 110 may identify the road on which the plurality of vehicles drives toward the intersection as a driving road. In this case, the driving road may be understood as a rear road in the present disclosure. In other words, based on the driving direction of a host vehicle, the road before the vehicle enters the intersection may be understood as a rear road, and the road that the vehicle enters via an intersection from the rear road may be understood as a front road.

According to an embodiment, the processor 110 may identify a non-host vehicle, other than the host vehicle, located in the first section within the preset distance from the starting point of the intersection on the driving road. The identifying may be dynamically (e.g., in real time) performed while the host vehicle is driving on the driving road.

For example, the starting point of an intersection on a driving road may include the point where the driving road and the intersection meet. The point where the driving road and the intersection meet may include a point where the driving road connects to another road. The point may include a point where a stop line is located on the driving road and exists before the vehicle enters the intersection. As a specific example, in the case of an intersection where a first road, a second road, a third road, and a fourth road meet, each road may include a starting point of the intersection. Accordingly, a total of four starting points of the intersection may be identified. In this case, if any one vehicle identified by the processor 110 travels on the first road, the processor 110 may identify the first road as the driving road. In addition, the processor 110 may identify the starting point of the intersection located on the first road as the starting point of the intersection on the driving road.

According to an embodiment, the first section within the preset distance from the starting point of an intersection on a driving road may be located on the driving road before the vehicle enters the intersection. For example, it may be assumed that one vehicle identified by the processor 110 drives on the first road, and it may be also assumed that the one vehicle passes via the intersection on the first road and enters the second road. In this case, the first section within the preset distance from the starting point of the intersection on the driving road may be located on the first road, not the second road.

According to an embodiment, the preset distance for the first section may be set as a distance that may be used as a basis for determining which vehicle is expected to block the intersection. For example, the preset distance for the first section may be set as a reference distance for evaluating the possibility of a vehicle approaching and entering an intersection. Such a distance may be used to identify a vehicle that may block an intersection and may serve as a basis for determining the location of a vehicle involved in attempting to enter the intersection. Therefore, a vehicle located within the first section may be identified as a vehicle with a high probability of entering the intersection.

According to an embodiment, the processor 110 may identify a host vehicle located in the first section among a plurality of vehicles driving on a road before the vehicle enters an intersection. The processor 110 may identify a non-host vehicle, other than any one of the plurality of vehicles described above, among the vehicles located in the first section. In this case, the host vehicle may include a vehicle receiving information related to an intersection. The non-host vehicle other than any one of the vehicles may include a vehicle traveling ahead of the vehicle receiving the intersection-related information.

According to an embodiment, the processor 110 may identify the non-host vehicle as an intersection-blocking predicted vehicle based on the non-host vehicle being stopped. In other words, the processor 110 may identify the non-host vehicle as an intersection-blocking predicted vehicle if the non-host vehicle is stopped in the first section.

According to an embodiment, an intersection-blocking predicted vehicle may mean a vehicle that is stopped in the section before the vehicle enters the intersection or a vehicle that is likely to block the intersection. An intersection-blocking predicted vehicle may be identified as a vehicle approaching or positioned within an intersection that is likely to impede the passage of other vehicles. The processor 110 may analyze various data, such as the vehicle's location, speed, stopping time, and relative distance from an intersection, to identify such vehicles.

For example, if a vehicle ‘K’ remains stationary in the first section within a preset distance from the starting point of an intersection without moving for a specified time period (e.g., 10 seconds or more), the processor 110 may identify the vehicle ‘K’ as an intersection-blocking predicted vehicle. This may be based on the analysis that the stopping time of the vehicle ‘K’ is longer than the remaining time of the driving signal at the intersection, and this may cause traffic congestion at the intersection. In detail, the vehicle ‘K’ may be determined as a vehicle with a high probability of entering the intersection without considering the remaining time of the driving signal at the intersection.

As another example, a vehicle ‘L’ may travel at a slow speed in the first section within a preset distance from the starting point of the intersection and stop just before entering the intersection. In this case, the processor 110 may determine the vehicle ‘L’ as a vehicle likely to block the intersection and may identify the vehicle ‘L’ as an intersection-blocking predicted vehicle. In detail, if the vehicle ‘L’ is analyzed as likely to cause traffic congestion at an intersection, considering the speed at which the vehicle ‘L’ is driving in the first section and the remaining time of the traffic signal, the vehicle ‘L’ may be identified as an intersection-blocking predicted vehicle.

According to an embodiment, the processor 110 may provide information about an intersection to the host vehicle driving on the road based on the identification of an intersection-blocking predicted vehicle.

According to an embodiment, if an intersection-blocking predicted vehicle is identified, the processor 110 may provide the information about the intersection to the host vehicle driving on the road. In this case, the vehicle receiving the information about the intersection may include a vehicle traveling toward the intersection and behind the intersection-blocking predicted vehicle.

For example, a host vehicle traveling toward the intersection and behind the intersection-blocking predicted vehicle may include a following vehicle driving behind the intersection-blocking predicted vehicle. In one embodiment, when an intersection-blocking predicted vehicle is identified on the driving road, information related to the intersection may be provided to the following vehicle so that the following vehicle can determine whether to enter the intersection in advance or select an alternative route. Thus, the following vehicle (i.e., the host vehicle) may be controlled to enter the intersection before the intersection-blocking predicted vehicle (i.e., the non-host vehicle) enters the intersection. Alternatively, the following vehicle (i.e., the host vehicle) may be controlled to drive along the alternative route.

In one embodiment, the processor may transmit the information related to the intersection to the following vehicle in real time through vehicle-to-vehicle (V2V) communication, server-based communication, or a navigation system of the vehicle.

In one embodiment, the following vehicle may provide the information related to the intersection to a user using a display or audio system of the vehicle.

In one embodiment, the following vehicle may interwork the information related to the intersection with an autonomous driving control system. Through this, driver intervention in the driving of the following vehicle may be minimized.

In one embodiment, the processor may activate an information provision trigger for the following vehicle when a certain condition is satisfied. In other words, the information related to the intersection may be transmitted to the following vehicle when the information provision trigger is activated.

For example, the information provision trigger may be activated when one of the vehicles on the driving road approaches within a preset distance from a starting point of the intersection, when a preset time before a time point at which a signal state of a traffic light at the intersection is changed to a stop signal or a caution signal has arrived, when the non-host vehicle is in a stopped state in the first section for a preset time or more, or when a congestion level of a front road is greater than or equal to a threshold.

The information provision trigger may contribute to reducing unnecessary provision of information and providing the information to a driver at an appropriate time.

According to an embodiment, the information about the intersection may include at least one of a predicted congestion level of the intersection, a speed of the intersection-blocking predicted vehicle, a predicted time required to reach the starting point of the intersection, the number of intersection-blocking predicted vehicles, the signal state of a traffic light at the intersection, or information for guiding an alternative route, or any combination thereof.

For example, the predicted congestion level at an intersection may include the congestion level of vehicles entering the intersection at a particular point in time or vehicles about to enter the intersection.

The processor 110 may determine the congestion level at an intersection based on at least one of a signal time period in which the same signal is repeated at a traffic light at the intersection, an average value of the number of vehicles passing via the intersection during the signal time period, the maximum value of a waiting time of the one other vehicle during the signal time period, an average value of the waiting time of the one other vehicle during the signal time period, a length of a driving road, an average speed of the one other vehicle driving on the driving road, or any combination thereof. For example, if the number of vehicles approaching an intersection increases steadily during a specified time period, or if congestion occurs within the intersection, the congestion level may be estimated as high.

For example, the speed of an intersection-blocking predicted vehicle may mean the current speed of a vehicle entering the intersection.

The processor 110 may analyze the speed of an intersection-blocking predicted vehicle to determine whether the intersection-blocking predicted vehicle may pass via the intersection normally. For example, if a vehicle is moving at a very slow speed or is stopped within the first section, it may be determined that the vehicle may not pass via the intersection normally.

For example, the estimated time to reach the starting point of an intersection may include the estimated time it takes for a vehicle to reach the starting point of the intersection from its current location. The estimated time to reach the beginning of an intersection may be calculated from the vehicle's current speed and the remaining distance to the intersection. Vehicles with a shorter estimated time may be more likely to enter the intersection, while vehicles with a longer estimated time may be more likely to stop before entering the intersection.

For example, the signal status of a traffic light at an intersection may mean the signal status of a traffic light at an intersection. A traffic light at an intersection may include a traffic light that indicates a traffic signal for vehicles traveling toward the intersection from the driving road. A traffic light state at an intersection may include at least one of a driving signal (green), a stop signal (red), or a caution signal (yellow), or any combination thereof. The processor 110 may receive the signal status of a traffic light at an intersection in real time. The processor 110 may determine the possibility of the vehicle blocking the intersection by comparing the expected entry time of the vehicle with the signal status. In one embodiment, if a vehicle is approaching an intersection and the traffic signal is expected to change to a stop signal, the vehicle may be identified as an intersection-blocking predicted vehicle.

For example, information for guiding an alternative route may include information for guiding a detour or an alternative route if traffic congestion is expected due to an intersection-blocking predicted vehicle or a vehicle approaching an intersection.

According to an embodiment, the processor 110 may identify the at least one other vehicle as the intersection-blocking predicted vehicle based on at least one of a distance between the at least one other vehicle and the intersection, a distance traveled by the at least one other vehicle in the first section, a time that the at least one other vehicle stays in the first section, a time that the at least one other vehicle stops in the first section, a number of times that the at least one other vehicle stops in the first section, an average speed of the at least one other vehicle, or any combination thereof.

For example, the processor 110 may identify at least one other vehicle as an intersection-blocking predicted vehicle based on the distance between the at least one other vehicle and the intersection. The processor 110 may measure the distance between the vehicle and the intersection in real time to determine whether the vehicle is within the range where the vehicle may enter the intersection.

For example, the processor 110 may identify the non-host vehicle as an intersection-blocking predicted vehicle based on the distance that the at least one other vehicle travels in the first section. The processor 110 may determine that the intersection is congested if the vehicle hardly moves in the first section or does not drive more than a certain distance. In this case, it may be determined that a vehicle driving in the first section is likely to block the intersection.

For example, the processor 110 may identify the non-host vehicle as an intersection-blocking predicted vehicle based on the time that the non-host vehicle remains in the first section. For example, the processor 110 may determine that the intersection is congested as the time that the vehicle remains in the first section increases. In this case, it may be determined that a vehicle driving in the first section is likely to block the intersection.

For example, the processor 110 may identify the non-host vehicle as an intersection-blocking predicted vehicle based on the time for which the non-host vehicle is stopped in the first section. For example, the processor 110 may determine that the intersection is congested when the time that the vehicle is stopped in the first section becomes longer. In this case, it may be determined that a vehicle driving in the first section is likely to block the intersection. In one embodiment, if a vehicle is stopped in the first section for a certain threshold (e.g., 10 seconds), the vehicle may be identified as an intersection-blocking predicted vehicle.

For example, the processor 110 may identify the non-host vehicle as an intersection-blocking predicted vehicle based on the number of times the non-host vehicle stops in the first section. In this case, the number of stops may include the number of stops according to the signal time period of the intersection. In one embodiment, the number of stops may include the number of stops for a specific threshold time or longer.

For example, the processor 110 may identify the non-host vehicle as an intersection-blocking predicted vehicle based on an average speed of the non-host vehicle. In this case, the average speed may include at least one of an average speed on the road before entering the intersection, an average speed in the first section, or any combination thereof. In one embodiment, if a vehicle is traveling at an average speed below a certain threshold value (e.g., 5 km/h) in the first section, the vehicle may be identified as an intersection-blocking predicted vehicle.

For example, the processor 110 may identify the non-host vehicle as an intersection-blocking predicted vehicle based on a result determined by combining a plurality of data. In this case, the data may include the distance between the non-host vehicle and the intersection, the distance traveled by the non-host vehicle in the first section, the time that the non-host vehicle stays in the first section, the time that the non-host vehicle stops in the first section, the number of times that the non-host vehicle stops in the first section, or the average speed of the non-host vehicle.

According to an embodiment, the processor 110 may identify the non-host vehicle as the intersection-blocking predicted vehicle based on a rate of change in the distance traveled by the non-host vehicle in the first section relative to the time that the non-host vehicle stays in the first section.

For example, the processor 110 may identify the non-host vehicle as an intersection-blocking predicted vehicle if the rate of change in the distance traveled by the non-host vehicle in the first section compared to the time that the non-host vehicle stayed in the first section is less than a threshold value.

In one embodiment, the processor 110 may determine that the non-host vehicle has stopped in the first section if the rate of change in the distance traveled by the non-host vehicle in the first section is ‘0 (zero)’ compared to the time for which the non-host vehicle stays in the first section. The processor 110 may identify the non-host vehicle as an intersection-blocking predicted vehicle based on at least one of the time that the non-host vehicle has stopped in the first section, the number of times that the non-host vehicle has stopped in the first section, or any combination thereof.

According to an embodiment, the processor 110 may calculate a rate of change in a distance traveled by the non-host vehicle relative to a driving time of the non-host vehicle. In addition, the processor 110 may identify whether the non-host vehicle is located in the first section. The processor 110 may identify the non-host vehicle as an intersection-blocking predicted vehicle by combining a rate of change in a distance traveled by the non-host vehicle compared to a driving time of the non-host vehicle and whether at least one other vehicle is located in the first section.

According to an embodiment, the processor 110 may identify the distance between the location of a traffic light that is closest to the starting point of an intersection and the starting point of the intersection as a reference distance.

For example, if there is a traffic light different from the traffic light of the intersection between a vehicle driving toward the intersection and the intersection, the vehicle may stop or drive based on the signal status of the other traffic light. In this case, it may be difficult to determine whether the vehicle in question is likely to block the intersection. In addition, because the vehicle is not directly affected by the traffic lights at the intersection, information about whether it passes via the intersection normally may not be essential. Accordingly, the first section may be located within the distance from the starting point of the intersection to the location of the traffic light that is closest to the starting point of the intersection.

According to an embodiment, the processor 110 may determine the first section based on a value of a preset ratio to a reference distance.

For example, the processor 110 may dynamically determine the range of the first section by multiplying the reference distance by a preset ratio. As a specific example, if the reference distance is 1 km and the preset ratio is 0.1 (10%), the first section may be determined as a road section within 100 m from the starting point of the intersection. The preset ratio may be adjusted based on the driving road, traffic conditions, road conditions, vehicle speed, or the like.

According to an embodiment, the processor 110 may identify the signal state of a traffic light at an intersection. For example, signal states may include a driving signal (green), a stop signal (red), and a caution signal (yellow).

According to an embodiment, the processor 110 may identify the remaining time from the time when the signal state is a driving signal to the time point when the driving signal changes to a stop signal or a caution signal. The remaining time may be considered when the possibility of entering the intersection and the driving path when the vehicle approaches the intersection are determined.

For example, the remaining time may be calculated in real time by communicating with a traffic light control system of the intersection. The processor 110 may receive the signal time period (cycle time) and the current signal state and may calculate the remaining time until the signal changes based on them. For example, if a traffic signal has been on for 30 seconds and 20 seconds have passed since the current signal started, the remaining time may be calculated as 10 seconds. In addition, the processor 110 may receive data directly from the traffic light control system or may independently calculate the remaining time in conjunction with a cycle timer.

According to an embodiment, the processor 110 may identify the non-host vehicle as an intersection-blocking predicted vehicle based on the remaining time being within a preset time. In this case, the preset time may include a time range during which the non-host vehicle has difficulty passing via the intersection normally. In other words, if the remaining time is within the preset time, it may be determined that the non-host vehicle will have difficulty passing via the intersection normally.

For example, the processor 110 may calculate the expected time for the vehicle to reach the starting point of the intersection based on the remaining distance from the current location of the vehicle to the starting point of the intersection and the current driving speed of the vehicle. In addition, the processor 110 may evaluate whether the vehicle may pass via the intersection by comparing the time point at which the vehicle is expected to reach the starting point of the intersection with the remaining time until the driving signal of the intersection traffic light changes to a stop signal or a caution signal. In this case, if the remaining time is within the preset time, the processor 110 may determine that it is difficult for the vehicle to pass via the intersection.

For example, if the remaining time is within a preset time, the processor 110 may determine that it is difficult for the vehicle to pass via the intersection. In detail, it may be assumed that the vehicle ‘K’ is located 10 m from the starting point of the intersection, and it may be assumed that the vehicle ‘K’ moves very slowly at a speed of 10 km/h. In this case, if the preset time related to the remaining time of the traffic light is 5 seconds and the remaining time of the traffic light at the intersection is identified as 3 seconds, it may be determined that there is a high possibility that the vehicle ‘K’ will not be able to completely pass via the intersection. In this case, the processor 110 may identify the vehicle ‘K’ as an intersection-blocking predicted vehicle.

According to an embodiment, the processor 110 may identify a front road on which the other vehicle may pass via the intersection via the driving road.

For example, at an intersection where a first road, a second road, a third road, and a fourth road meet, if a vehicle traveling on the first road may only pass via the intersection and travel on the second road, the second road may be identified as the front road. If a vehicle driving on the first road passes via the intersection and drives onto the second road or the third road, the front road may be identified based on the lane in which the vehicle drives. If a vehicle drives in a lane to enter the second road, the second road may be identified as the front road. If a vehicle drives in a lane to enter the third road, the third road may be identified as the front road.

According to an embodiment, the processor 110 may determine the congestion level of the front road based on first traffic volume data including at least one of a length of the front road, the number of vehicles on the front road, the density of vehicles on the front road, the speed of a vehicle on the front road, or any combination thereof.

For example, the density of vehicles may be calculated based on the number of vehicles on the road relative to the length of the road. Accordingly, the processor 110 may calculate the density of vehicles on the front road by dividing the number of vehicles on the front road by the length of the front road. It may be determined that the congestion level of the front road increases when the density of vehicles on the front road increases. It may be determined that the front road is more congested when the congestion level on the front road increases.

For example, the processor 110 may determine the congestion level of the front road by dividing it into three states such as congestion, delay, or smoothness. In this case, the congestion level of the front road may increase in the order of smoothness, delay, and congestion. In other words, the congestion level of the front road may be higher during congestion than during delays.

According to an embodiment, the processor 110 may determine the congestion level of the front road by comparing second traffic volume data of the front road collected during a preset past time period with first traffic volume data.

For example, the processor 110 may continuously identify traffic volume data related to the congestion level of the front road. In this case, the traffic volume data of the front road collected during the preset past time period may be identified as the second traffic volume data. The preset past time period may be set as a period during which sufficient data may be accumulated to enable a relative evaluation of the current congestion level of the front road compared to the past. For example, the preset past time period may be set to two weeks or more.

For example, the processor 110 may determine the congestion level of the front road by analyzing the difference between the first traffic volume data and the second traffic volume data. The processor 110 may determine the current congestion level of the front road by comparing the current first traffic volume data with the second traffic volume data at the time point when an intersection-blocking predicted vehicle was identified in the past. As a specific example, if the current density of vehicles on the front road is more than 90% of the density of vehicles on the front road at the time point when the intersection-blocking predicted vehicle was identified in the past, the current congestion level of the front road may be determined as ‘congestion’.

According to an embodiment, the processor 110 may determine the congestion level of a driving road based on the number of vehicles driving on the driving road.

In this case, the driving road may mean the road before the vehicle enters the intersection based on the driving direction of the vehicle. In other words, the determining of the congestion level of the driving road by the processor 110 may be understood as being the same as determining the congestion level of the rear road before the vehicle enters the intersection.

A plurality of vehicles driving on a driving road may include a vehicle moving on the driving road and a vehicle stopped on the driving road.

According to an embodiment, the processor 110 may identify the average number of vehicles that may pass via the intersection while the traffic light at the intersection is a driving signal.

The processor 110 may determine the congestion level of the driving road by comparing the number of vehicles driving on the road with the average number of vehicles that may pass via the intersection.

For example, the average number of vehicles that may pass via an intersection may be identified as 13. The processor 110 may determine the congestion level of the road as ‘smoothness’ if the number of vehicles driving on the driving road is 13 or less. In addition, the processor 110 may determine the congestion level of the driving road as ‘delay’ if the number of vehicles driving on the driving road between 13 and 26. In addition, the processor 110 may determine the congestion level of the driving road as ‘traffic congestion’ if the number of vehicles driving on the driving road exceeds 26.

According to an embodiment, the processor 110 may determine the congestion level of the driving road based on at least one of a signal time period in which the same signal is repeated at a traffic light at the intersection, an average value of the number of vehicles passing via the intersection during the signal time period, the maximum value of a waiting time of one other vehicle during the signal time period, an average value of the waiting time of the one other vehicle during the signal time period, a length of the driving road, an average speed of the non-host vehicle driving on the driving road, or any combination thereof.

In this case, the signal time period may mean the time of one cycle in which the same signal pattern (driving signal, caution signal, stop signal, or the like) is repeated. The signal time period may include the sum of the times that each signal state lasts. For example, the signal time period during which a driving signal, a caution signal, and a stop signal repeat may include the sum of the time the driving signal lasts, the time the caution signal lasts, and the time the stop signal lasts.

According to an embodiment, the processor 110 may determine the congestion level of the driving road based on the length of the driving road and the signal time period. Each driving road may have a different length, and each intersection may have a different signal time period. Therefore, it is necessary to determine the congestion level of the driving road by considering the length of the driving road and the signal time period. In this case, the processor 110 may calculate the average driving speed of the vehicle based on the length of the driving road and the signal time period. The processor 110 may determine the congestion level of the driving road by comparing the average driving speed of a vehicle based on the length of the driving road and the signal time period with a preset reference speed.

For example, the processor 110 may identify the time that a vehicle waits without entering an intersection as a signal waiting time. The signal waiting time may refer to the time a vehicle is stopped on the driving road before the vehicle enters an intersection. The signal waiting time may be calculated based on the number of signal time periods the vehicle waits to pass via the intersection. For example, if a vehicle does not pass via an intersection during two signal time periods, the signal waiting time may include the time elapsed between two repetitions of the signal time period.

For example, the processor 110 may identify the time the vehicle drives on the driving road. In this case, the time that the vehicle travels on the driving road may only include the time that the vehicle moves without stopping.

For example, the processor 110 may calculate the average driving speed of the vehicle based on the signal waiting time, the time the vehicle travels on the driving road, and the length of the driving road. In an embodiment, the average driving speed of a vehicle may be calculated by dividing the ‘length of the driving road’ by the sum of the ‘signal waiting time’ and the ‘time for which the vehicle drives on the driving road’.

According to an embodiment, the processor 110 may determine the congestion level of the driving road by comparing the average driving speed of the vehicle with the preset reference speed. The preset reference speed may include at least one of a first reference speed that is used to determine the congestion level as ‘traffic congestion’, a second reference speed that is used to determine the congestion level as ‘smooth’, or any combination thereof. This is only an example, and the number of reference speeds may vary based on the number of states used to distinguish congestion levels.

For example, the processor 110 may determine the congestion level of the driving road as ‘traffic congestion’ if the average driving speed of the vehicle is less than the first reference speed.

For example, the processor 110 may determine the congestion level of the driving road as ‘smoothness’ if the average driving speed of the vehicle exceeds the second reference speed.

For example, the processor 110 may determine the congestion level of a driving road as ‘delay’ if the average driving speed of the vehicle is greater than or equal to the first reference speed and less than or equal to the second reference speed.

In one embodiment, the processor may identify the intersection-blocking predicted vehicle using a rule-based decision algorithm. For example, the processor may identify the intersection-blocking predicted vehicle based on at least one of a distance between the non-host vehicle and the intersection, a distance traveled by the non-host vehicle in the first section, a time that the non-host vehicle stays in the first section, a time that the at least one other vehicle stops in the first section, a number of times that the non-host vehicle stops in the first section, or an average speed of the non-host vehicle.

In one embodiment, the processor may identify the intersection-blocking predicted vehicle using a machine learning-based decision model that is trained on multiple types of data, such as vehicle driving history, road congestion level, and signal state of the traffic light, in addition to the rule-based method.

For example, the processor may utilize various algorithms such as deep learning, decision trees, support vector machines (SVM), or random forests to predict whether the non-host vehicle is likely to block the intersection. The machine learning-based decision model may improve the accuracy and adaptability of the prediction by leveraging traffic data collected in the past. Such a model may be used either in conjunction with or independently from the rule-based decision algorithm.

The apparatus for providing traffic information according to an embodiment may identify a vehicle likely to block an intersection and provide information related to the intersection and thus may alleviate congestion at the intersection.

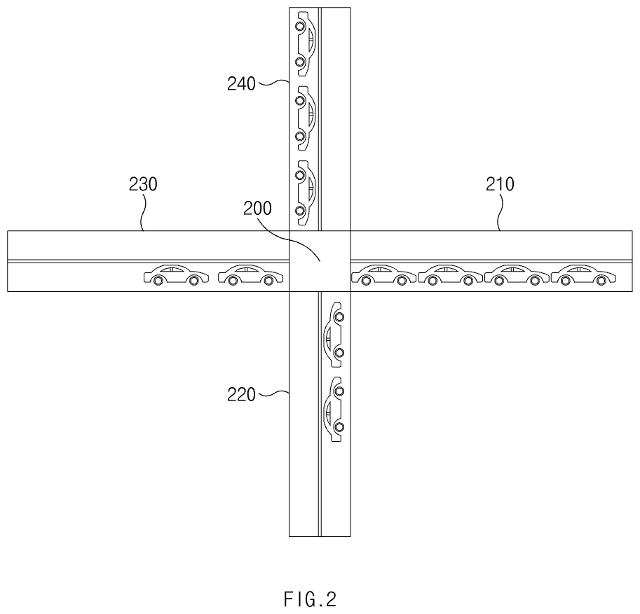

FIG. 2 is a diagram illustrating examples of a driving road, a front road, and an intersection identified by an apparatus for providing traffic information according to an embodiment of the present disclosure.

Referring to FIG. 2 according to an embodiment, a first road 210, a second road 220, a third road 230, and a fourth road 240 may be connected to an intersection 200. The intersection 200 may include a central area where the first road 210, the second road 220, the third road 230, and the fourth road 240 intersect or meet each other.

Considering the driving direction of the vehicle shown in FIG. 2 according to an embodiment, the first road 210, the third road 230, and the fourth road 240 may be identified as a driving road or a rear road, respectively.

According to an embodiment, if a vehicle receiving information about the intersection 200 is a vehicle driving on the first road 210, the first road 210 may be identified as a driving road or a rear road. Furthermore, if a vehicle on the first road 210 passes via the intersection 200 and enters the second road 220, the second road 220 may be identified as the front road.

However, this is only an example, and if the driving direction of the vehicle is different from that shown in FIG. 2, the front road and the rear road may also be identified as different roads from the roads described above.

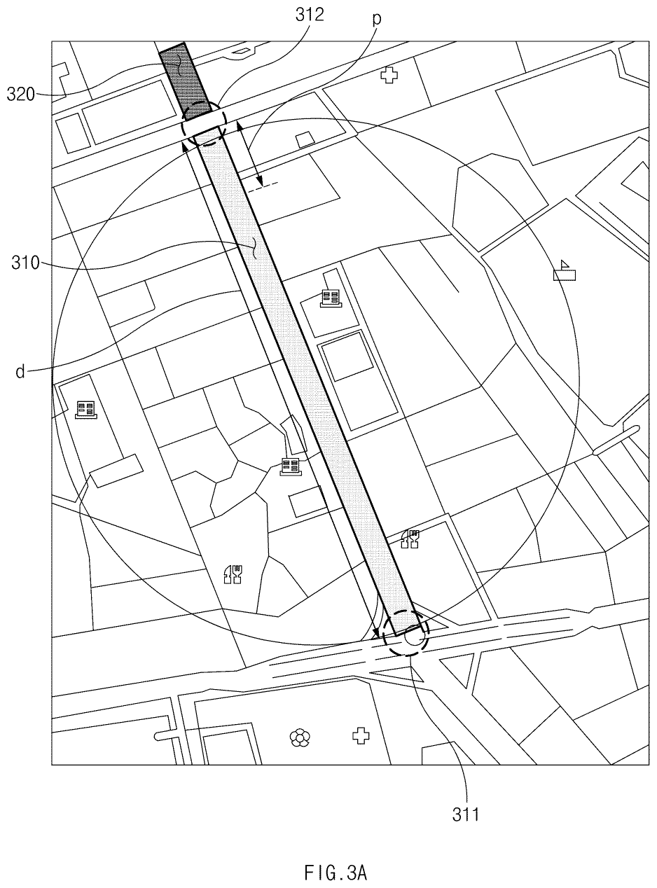

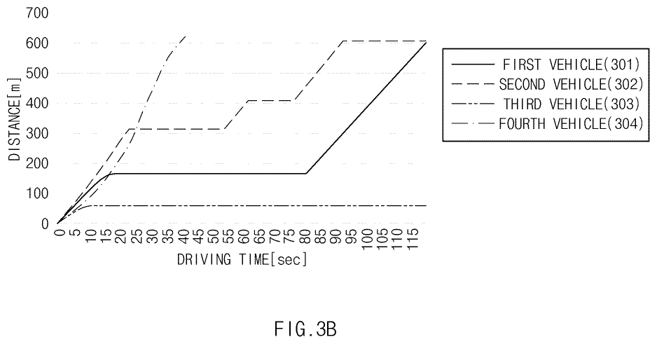

FIG. 3A is a diagram illustrating a first section within a preset distance from the starting point of an intersection on a driving road identified by an apparatus for providing traffic information according to an embodiment of the present disclosure.

The map of FIG. 3A according to an embodiment may include a driving road 310 that may be identified as a rear road, a starting point 311 of the driving road 310, an intersection 312, and a front road 320. Further, a vehicle driving on the driving road 310 may be understood as a vehicle driving from the starting point 311 of the driving road 310 to the intersection 312.

According to an embodiment, as described above in FIG. 1, if there is a traffic light different from the traffic light of the intersection 312 between a vehicle driving toward the intersection 312 and the intersection 312, it may be difficult to determine whether the vehicle is likely to block the intersection 312. Accordingly, there may be no traffic lights between the intersection 312 and the starting point 311 of the driving road 310. For example, referring to the map of FIG. 3A, a traffic light may only exist at the starting point 311 of the driving road 310 and the intersection 312.

According to an embodiment, the apparatus for providing traffic information may identify a length ‘d’ of the driving road 310. The length ‘d’ of the driving road 310 may be used to calculate a first section ‘p’ within the preset distance from the starting point of the intersection 312 on the driving road 310 or to determine the congestion level of the driving road 310.

The preset distance associated with the first section ‘p’ may be set as a reference distance for evaluating the possibility of a vehicle entering the intersection 312. For example, a vehicle located within the first section ‘p’ may be identified as a vehicle likely to enter the intersection 312.

According to an embodiment, the first section ‘p’ may be determined based on a value of a preset ratio to the length ‘d’ of the driving road 310. In one embodiment, if the length ‘d’ of the driving road 310 is 1 km and the preset ratio is 0.1 (10%), the first section ‘p’ may be determined as a road section within a distance of 100 m from the starting point of the intersection 312.

According to an embodiment, the congestion level of the driving road 310 may be determined based on the length ‘d’ of the driving road 310 and the signal time period. For example, the congestion level of the driving road 310 may be determined by comparing the average driving speed of a vehicle based on the length ‘d’ of the driving road 310 and the signal time period with a preset reference speed. In this case, the preset reference speed may include a reference speed that is used to determine a congestion level as ‘traffic congestion’, a reference speed that is used to determine a congestion level as ‘delay’, or a reference speed that is used to determine a congestion level as ‘smoothness’.

FIG. 3B is a graph illustrating changes in moving distance according to driving times of a plurality of vehicles identified by an apparatus for providing traffic information according to an embodiment of the present disclosure.

The graph of FIG. 3B according to an embodiment is a graph illustrating the driving states of vehicles driving on a driving road before entering an intersection. In this case, it may be assumed that the length of the driving road is 625 m.

The graph of FIG. 3B may include an x-axis indicating the time it takes for a vehicle to travel on the driving road and a y-axis indicating the distance the vehicle travels from the starting point of the driving road toward the intersection.

The graph of FIG. 3B may show the driving status of a first vehicle 301, a second vehicle 302, a third vehicle 303, and a fourth vehicle 304. In this case, the graph for the first vehicle 301, the graph for the second vehicle 302, the graph for the third vehicle 303, and the graph for the fourth vehicle 304 may be understood as separate graphs. For example, the first vehicle 301, the second vehicle 302, the third vehicle 303, and the fourth vehicle 304 may not have driven on the road at the same time.

The graph of FIG. 3B may illustrate a graph of the driving state of the first vehicle 301, the second vehicle 302, the third vehicle 303, or the fourth vehicle 304 from the starting point of the driving road until reaching the starting point of the intersection. For example, if the first vehicle 301, the second vehicle 302, the third vehicle 303, or the fourth vehicle 304 travels 625 m on the road, they may reach the starting point of the intersection.

According to an embodiment, the first vehicle 301 may stop according to a stop signal after 15 seconds from the time it started driving on the driving road. The first vehicle 301 may resume driving according to a driving signal after 80 seconds from the time it started driving on the driving road. The first vehicle 301 may continue driving for about 40 seconds and may enter the intersection.

Accordingly, the first vehicle 301 may not be identified as a vehicle likely to block the intersection. Referring to the driving state of the first vehicle 301 shown in FIG. 3B, the congestion level of the driving road may be determined to be ‘smooth’ if the first vehicle 301 drives on the driving road.

According to an embodiment, the second vehicle 302 may stop after 20 seconds from the time it started driving on the driving road. In addition, the second vehicle 302 may start driving again after remaining stopped for about 35 seconds. Referring to FIG. 3B, the second vehicle 302 may drive for about 5 seconds and then may stop again for 10 seconds. In addition, the second vehicle 302 may drive again for about 20 seconds and reach a distance of 625 m from the starting point of the driving road. In other words, the second vehicle 302 may reach the starting point of the intersection after stopping twice. Referring to FIG. 3B, the second vehicle 302 may remain stopped at the starting point of the intersection. This may mean a stop state in which a vehicle stops according to a stop signal or due to traffic congestion at an intersection.

Accordingly, the second vehicle 302 may be identified as a vehicle likely to block the intersection. Referring to the driving state of the second vehicle 302 shown in FIG. 3B, the congestion level of the driving road may be determined to be ‘traffic congestion’ if the second vehicle 302 drives on the driving road.

According to an embodiment, the third vehicle 303 may stop after 10 seconds from the time it started driving on the driving road. Referring to FIG. 3B, the third vehicle 303 may be stopped for about 110 seconds. Accordingly, it may be determined that the third vehicle 303 has not been able to move any further since the third vehicle 303 stopped due to traffic congestion on the driving road.

Referring to the driving state of the third vehicle 303 shown in FIG. 3B, if the third vehicle 303 drives on the driving road, the congestion level of the driving road may be determined to be ‘traffic congestion’.

According to an embodiment, the fourth vehicle 304 may travel 625 m without stopping after starting to drive on the driving road. In this case, the fourth vehicle 304 may reach the starting point of the intersection at one go without stopping.

Referring to the driving state of the fourth vehicle 304 shown in FIG. 3B, if the fourth vehicle 304 drives on the driving road, the congestion level of the driving road may be determined to be ‘smooth’.

Referring to FIG. 3B according to an embodiment, the apparatus for providing traffic information may determine the congestion level of a driving road based on the number of times or the time that a vehicle stops to reach the starting point of an intersection.

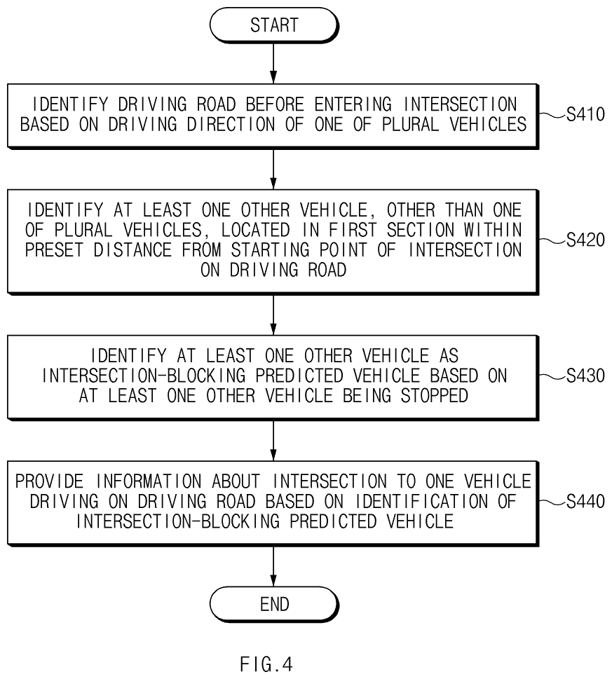

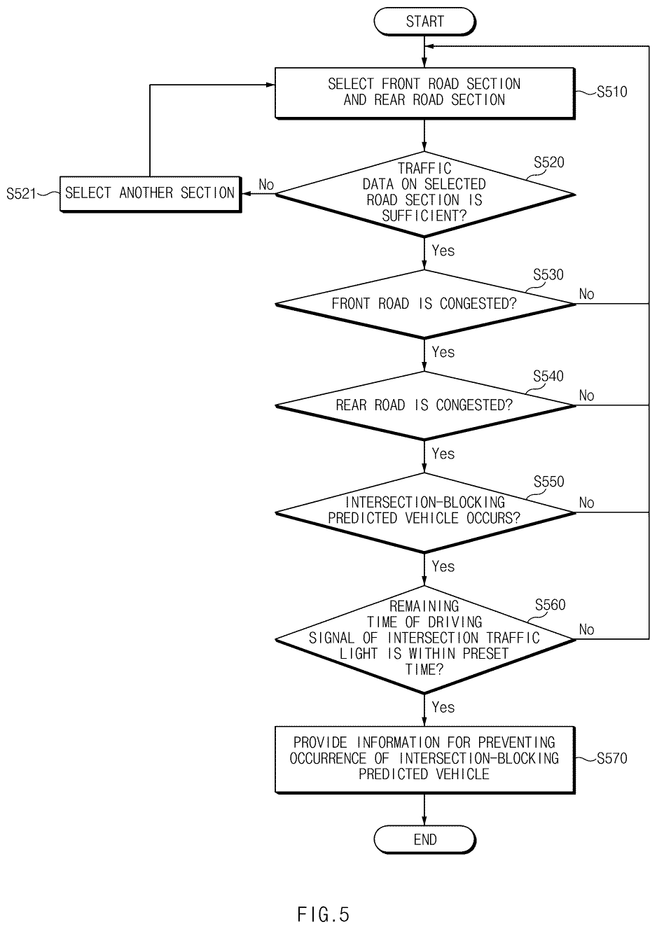

Hereinafter, with reference to FIGS. 4 and 5, an apparatus for providing traffic information or a method of providing traffic information according to an embodiment of the present disclosure is described in detail.

Hereinafter, the apparatus 100 for providing traffic information of FIG. 1 may perform the process of FIG. 4 or FIG. 5. In addition, in the description of FIG. 4 or FIG. 5, it may be understood that the operation described as being performed by the apparatus for providing traffic information is controlled by the processor 110 of the apparatus 100 for providing traffic information.

FIG. 4 is a flowchart illustrating an apparatus for providing traffic information or a method of providing traffic information according to an embodiment of the present disclosure.

According to an embodiment, in S410, an apparatus for providing traffic information may identify a driving road before entering an intersection based on a driving direction of one of a plurality of vehicles.

According to an embodiment, in S420, the apparatus for providing traffic information may identify the non-host vehicle, other than the one of the plurality of vehicles, located in the first section within the preset distance from the starting point of the intersection on the driving road.

According to an embodiment, in S430, the apparatus for providing traffic information may identify at least one other vehicle as an intersection-blocking predicted vehicle based on at least one other vehicle being stopped.

According to an embodiment, in S440, the apparatus for providing traffic information may provide information about the intersection to one vehicle driving on the road based on the identification of an intersection-blocking predicted vehicle.

Referring to FIG. 4 according to an embodiment, by identifying an intersection-blocking predicted vehicle and additionally preventing the occurrence of an intersection-blocking predicted vehicle, it is possible to effectively alleviate traffic congestion occurring at an intersection.

FIG. 5 is a flowchart illustrating an example of a process for providing information related to an intersection by an apparatus for providing traffic information or a method of providing traffic information according to an embodiment of the present disclosure.

According to an embodiment, in S510, an apparatus for providing traffic information may select a section of a front road and a section of a rear road. The apparatus for providing traffic information may select the front road and the rear road by collecting traffic data. For example, the apparatus for providing traffic information may receive the traffic data from a vehicle driving on a driving road connected to an intersection.

In this case, based on the driving direction of the vehicle, the road before the vehicle enters the intersection may be understood as the rear road, and the road that the vehicle enters via the intersection from the rear road may be understood as the front road.

According to an embodiment, in S520, the apparatus for providing traffic information may determine whether there is sufficient traffic data on a selected road section. For example, the apparatus for providing traffic information may determine whether the selected road is congested based on the collected traffic data. Therefore, if traffic data is not collected enough to determine whether a road is congested (No in S520), in S521, the apparatus for providing traffic information may select a section of another road.

According to an embodiment, if traffic data is not collected enough to determine whether a road is congested (Yes in S520), in S530, the apparatus for providing traffic information may determine whether the front road is congested. Whether the front road is congested may be determined by the congestion level of the front road.

For example, the apparatus for providing traffic information may determine the congestion level of the front road based on current traffic volume data including at least one of the length of the front road, the number of vehicles on the front road, the density of vehicles on the front road, the speed of a vehicle on the front road, or any combination thereof.

In one embodiment, the apparatus for providing traffic information may determine that the front road is congested if the past traffic volume data and the current traffic volume data are equal to or greater than 90% of the past traffic volume data. The past traffic volume data may include traffic volume data for a preset past time period.

According to an embodiment, if the front road is congested (Yes in S530), in S540, the apparatus for providing traffic information may determine whether the rear road is congested. Whether the rear road is congested may be determined by the congestion level of the rear road.

For example, the apparatus for providing traffic information may determine the congestion level of the rear road based on the number of vehicles driving on the rear road.

As a specific example, it is possible to determine the congestion level of the driving road by comparing the number of vehicles driving on the driving road with the average number of vehicles that pass via the intersection in a state where the traffic light at the intersection is a driving signal.

According to an embodiment, if the rear road is congested (Yes in S540), in S550, the apparatus for providing traffic information may determine whether there is an intersection-blocking predicted vehicle that is likely to block the intersection.

For example, if a vehicle is identified as stopped in the first section within a preset distance from the starting point of the intersection, the apparatus for providing traffic information may identify the corresponding vehicle as an intersection-blocking predicted vehicle. In one embodiment, whether a vehicle is stopped may be determined based on the rate of change in the distance the vehicle travels in the first section relative to the time the vehicle stays in the first section.

According to an embodiment, if there is an intersection-blocking predicted vehicle that is likely to block the intersection (Yes in S550), in S560, the apparatus for providing traffic information may determine whether the remaining time of a driving signal of an intersection traffic light is within a preset time. In this case, the remaining time may include the time remaining to the time point if the driving signal changes to a stop signal or a caution signal in a state where the driving signal is on. In this case, the preset time may include a time range during which at least one other vehicle has difficulty passing via the intersection normally. In other words, if the remaining time is within the preset time, it may be determined that at least one other vehicle has difficulty passing via the intersection normally.

According to an embodiment, if the remaining time of a driving signal of an intersection traffic light is within a preset time (Yes in S560), in S570, the apparatus for providing traffic information may provide information for preventing the occurrence of an intersection-blocking predicted vehicle to a vehicle (e.g., a host vehicle) driving on a driving road. The information for preventing the occurrence of an intersection-blocking predicted vehicle may include at least one of a predicted congestion level of the intersection, a speed of the intersection-blocking predicted vehicle, a predicted time required to reach the starting point of the intersection, the number of intersection-blocking predicted vehicles, the signal state of a traffic light at the intersection, information for guiding an alternative route, or any combination thereof.

According to an embodiment, operations S510 to S570 of FIG. 5 are illustrated sequentially, but operations S510 to S570 are not limited to the order, and some of the operations may be omitted. For example, operation S510 or operation S520 may be omitted. For example, operation S530 and operation S540 may be performed simultaneously.

Referring to FIG. 5 according to an embodiment, by more accurately predicting a vehicle likely to block an intersection, a user who is provided with information about an intersection may accurately determine whether to enter the intersection.

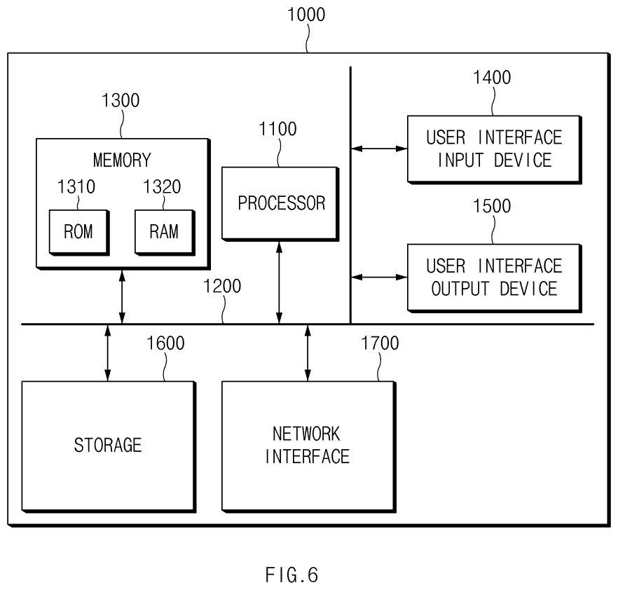

FIG. 6 is a block diagram illustrating a computing system related to an apparatus for providing traffic information or a method of providing traffic information according to an embodiment of the present disclosure.

Referring to FIG. 6, a computing system 1000 may include at least one processor 1100, a memory 1300, a user interface input device 1400, a user interface output device 1500 (e.g., a communication interface, a network interface, a user input/output interface, or the like), a storage 1600, and a network interface 1700, which are connected via a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or the algorithm described according to the embodiments of the present disclosure may be implemented directly by hardware executed by the processor 1100, a software module, or any combination thereof. The software module may reside in a storage medium (i.e., the memory 1300 and/or the storage 1600), such as a RAM, a flash memory, a ROM, an EPROM, an EEPROM, a register, a hard disk, a detachable disk, or a CD-ROM.

The storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the present technology, it is possible to effectively alleviate traffic congestion occurring at an intersection by identifying an intersection-blocking predicted vehicle and additionally preventing the occurrence of an intersection-blocking predicted vehicle.

In addition, according to the present technology, it is possible to comprehensively analyze traffic conditions of a front road and a rear road to inform a driver of whether the driver may pass via an intersection.

In addition, according to the present technology, it is possible to improve the quality of a route guided by a real-time route search system and prevent unnecessary detours by reducing traffic congestion at an intersection.

In addition, according to the present technology, it is possible to increase user convenience by providing useful traffic information, such as alternative routes, expected congestion, and the like, to a vehicle entering an intersection.

In addition, according to the present technology, it is possible to automatically determine whether an intersection may be passed and provide the information to the user. Thus, the burden on drivers to make their own decisions may be reduced, and risks due to the entry of the vehicle into an intersection may be minimized.

In addition, according to the present technology, it is possible to support a user to make faster and more efficient decisions by providing the user with the results of determining whether an intersection is passable and the congestion level of a driving road.

In addition, various effects that are directly or indirectly understood via the present disclosure may be provided.

Although embodiments of the present disclosure have been described for illustrative purposes, those having ordinary skill in the art should appreciate that various modifications, additions, and substitutions are possible, without departing from the scope and spirit of the present disclosure.

Therefore, the embodiments disclosed in the present disclosure are provided for the sake of descriptions and are not intended to limit the technical concepts of the present disclosure. It should be understood that such embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for providing traffic information, the apparatus comprising:
a memory configured to store a program instruction; and
a processor configured, by executing the program instruction, to:
identify a driving road before a host vehicle among a plurality of vehicles enters an intersection based on a driving direction of the host vehicle;
dynamically identify a non-host vehicle among the plurality of vehicles while the host vehicle is driving on the driving road, the non-host vehicle located in a first section within a preset distance from a starting point of the intersection on the driving road;
identify the non-host vehicle as an intersection-blocking predicted vehicle based on the non-host vehicle being stopped;
provide information related to the intersection to the host vehicle driving on the driving road based on the identified intersection-blocking predicted vehicle; and
control the host vehicle to enter the intersection before the identified intersection-blocking predicted vehicle enters the intersection or drive along an alternative route.

2. The apparatus of claim 1, wherein the processor is configured to identify the non-host vehicle as the intersection-blocking predicted vehicle based on at least one of a distance between the non-host vehicle and the intersection, a distance traveled by the non-host vehicle in the first section, a time that the non-host vehicle stays in the first section, a time that the non-host vehicle stops in the first section, a number of times that the non-host vehicle stops in the first section, an average speed of the non-host vehicle, or a combination thereof.

3. The apparatus of claim 2, wherein the processor is configured to identify the non-host vehicle as the intersection-blocking predicted vehicle based on a rate of change in the distance traveled by the non-host vehicle in the first section relative to the time when the non-host vehicle stays in the first section.

4. The apparatus of claim 1, wherein the processor is configured to:
identify a distance from a location of a traffic light that exists closest to the starting point of the intersection to the starting point of the intersection as a reference distance; and
determine the first section based on a value of a preset ratio for the reference distance.

5. The apparatus of claim 1, wherein the processor is configured to:
identify a signal state of a traffic light at the intersection;
identify a remaining time until a driving signal changes to a stop signal or a caution signal; and
identify the non-host vehicle as the intersection-blocking predicted vehicle based on the remaining time being less than a preset time.

6. The apparatus of claim 1, wherein the processor is configured to:
identify a front road on which the non-host vehicle is able to pass via the intersection via the driving road; and
determine a congestion level of the front road based on first traffic volume data including at least one of a length of the front road, a number of vehicles on the front road, a density of vehicles on the front road, a speed of a vehicle on the front road, or a combination thereof.

7. The apparatus of claim 6, wherein the processor is configured to compare second traffic volume data of the front road collected during a preset past time period with the first traffic volume data to determine the congestion level of the front road.

8. The apparatus of claim 1, wherein the processor is configured to determine a congestion level of the driving road based on a number of the plurality of vehicles driving on the driving road.

9. The apparatus of claim 8, wherein the processor is configured to determine the congestion level of the driving road based on at least one of a signal time period in which a same signal is repeated at a traffic light at the intersection, an average value of a number of vehicles passing the intersection during the signal time period, a maximum value of a waiting time of the non-host vehicle during the signal time period, an average value of the waiting time of the non-host vehicle during the signal time period, a length of the driving road, an average speed of the non-host vehicle driving on the driving road, or a combination thereof.

10. The apparatus of claim 1, wherein the information related to the intersection includes at least one of a predicted congestion level of the intersection, a speed of the intersection-blocking predicted vehicle, a predicted time required to reach the starting point of the intersection, a number of intersection-blocking predicted vehicles, a signal state of a traffic light at the intersection, information for guiding an alternative route, or a combination thereof.

11. A method of providing traffic information, the method comprising:
identifying, by a processor, a driving road before a host vehicle among a plurality of vehicles enters an intersection based on a driving direction of the host vehicle;
dynamically identifying, by the processor, a non-host vehicle among the plurality of vehicles while the host vehicle is driving on the driving road, the non-host vehicle located in a first section within a preset distance from a starting point of the intersection on the driving road;
identifying, by the processor, the non-host vehicle as an intersection-blocking predicted vehicle based on the non-host vehicle being stopped;
providing, by the processor, information related to the intersection to the host vehicle driving on the driving road based on the identified intersection-blocking predicted vehicle; and
controlling the host vehicle to enter the intersection before the identified intersection-blocking predicted vehicle enters the intersection or drive along an alternative route.

12. The method of claim 11, wherein identifying the non-host vehicle as the intersection-blocking predicted vehicle includes identifying, by the processor, the non-host vehicle as the intersection-blocking predicted vehicle based on at least one of a distance between the non-host vehicle and the intersection, a distance traveled by the non-host vehicle in the first section, a time that the non-host vehicle stays in the first section, a time that the non-host vehicle stops in the first section, a number of times that the non-host vehicle stops in the first section, an average speed of the non-host vehicle, or a combination thereof.

13. The method of claim 12, wherein identifying the non-host vehicle as the intersection-blocking predicted vehicle includes identifying, by the processor, the non-host vehicle as the intersection-blocking predicted vehicle based on a rate of change in the distance traveled by the non-host vehicle in the first section relative to the time when the non-host vehicle stays in the first section.

14. The method of claim 11, wherein identifying the non-host vehicle includes:
identifying, by the processor, a location of a traffic light that exists closest to the starting point of the intersection and a distance to the starting point of the intersection as a reference distance; and
determining, by the processor, the first section based on a value of a preset ratio for the reference distance.

15. The method of claim 11, wherein identifying the non-host vehicle as the intersection-blocking predicted vehicle includes:
identifying, by the processor, a signal state of a traffic light at the intersection;
identifying, by the processor, a remaining time until a driving signal changes to a stop signal or a caution signal; and
identifying, by the processor, the non-host vehicle as the intersection-blocking predicted vehicle based on the remaining time being less than a preset time.

16. The method of claim 11, further comprising:
identifying, by the processor, a front road on which the non-host vehicle is able to pass via the intersection via the driving road; and
determining, by the processor, a congestion level of the front road based on first traffic volume data including at least one of a length of the front road, a number of vehicles on the front road, a density of vehicles on the front road, a speed of a vehicle on the front road, or a combination thereof.

17. The method of claim 16, wherein determining the congestion level of the front road includes comparing, by the processor, second traffic volume data of the front road collected during a preset past time period with the first traffic volume data to determine the congestion level of the front road.

18. The method of claim 11, further comprising:
determining, by the processor, a congestion level of the driving road based on a number of the plurality of vehicles driving on the driving road.

19. The method of claim 18, wherein determining the congestion level of the driving road includes determining, by the processor, the congestion level of the driving road based on at least one of a signal time period in which a same signal is repeated at a traffic light at the intersection, an average value of a number of vehicles passing the intersection during the signal time period, a maximum value of a waiting time of the non-host vehicle during the signal time period, an average value of the waiting time of the one other vehicle during the signal time period, a length of the driving road, or an average speed of the non-host vehicle driving on the driving road, or a combination thereof.

20. The method of claim 11, wherein the information related to the intersection includes at least one of a predicted congestion level of the intersection, a speed of the intersection-blocking predicted vehicle, a predicted time required to reach the starting point of the intersection, a number of intersection-blocking predicted vehicles, a signal state of a traffic light at the intersection, information for guiding an alternative route, or a combination thereof.
